(19) United States
(12) Patent Application Publication
(10) Pub. No.: US 2006/0262952 A1
(43) Pub. Date: Nov. 23, 2006

(54) HEARING-AID REMOTE CONTROL

(75) Inventors: Josef Wagner, Lachen (CH); Herbert Bachler, Meilen (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 11/456,238

(22) Filed: Jul. 10, 2006

Related U.S. Application Data
(62) Division of application No. 10/655,383, filed on Sep. 4, 2003.
(63) Continuation-in-part of application No. 10/368,273, filed on Feb. 18, 2003.

(51) Int. Cl. H04R 25/00

(52) U.S. Cl. 381/315

(57) ABSTRACT

A remote control unit for wireless control of an electrical microdevice, such as a hearing aid or implanted medical device. An object worn or carried by a person, such as a wristwatch has a band attached thereto. A housing containing electronic circuitry of the remote control is arranged within the band. Operation elements, such as pushbuttons, are provided on the housing and project through the band or are operable through the band.

### CROSS-REFERENCE TO RELATED APPLICATION

This application is a Divisional of U.S. utility application Ser. No. 10/655,383, filed Sep. 4, 2003, which is a Continuation-In-Part of U.S. Ser. No. 10/368,273 filed Feb. 18, 2003.

### BACKGROUND OF THE INVENTION

This invention relates to a remote control for electric and electronic microdevices such as communication transceivers and hearing aids as well as medical devices as e.g. implants, allowing their wireless operation as specified in the characterizing feature of claim 1; to a communication-transceiver or hearing-aid remote control unit designed for integration in a wristwatch; and to a hearing aid with a remote control for the operation of said hearing aid.

Wireless remote controls used to operate hearing aids, for one example, have been known before. A remote control for hearing aids, to be separately carried by a person, has been described for instance in Swiss patent CH-PS 670.349. That unit constitutes one more device that must be kept handy by the individual for any necessary intervention in the operation of his or her hearing aid. But not everybody is willing to take out an anything but inconspicuous remote control device in public in order to make necessary changes to its settings, thus making it evident that he or she is wearing a hearing aid which, after all, most wearers would rather conceal.

It is for that reason that EP 1 247 423 suggests incorporating the remote control for a hearing aid for instance in a wristwatch. Based on that idea, various suppliers of electronic microdevices such as hearing aids are marketing two or three design variations of watches that contain such a remote control. As it turns out, however, the watch models selected for instance by the makers of hearing aids for the integration of a remote control are not to the liking of all customers, given that for most people a watch is very much a matter of personal taste. On the other hand, of course, it is not possible to incorporate a remote control in just any watch design. It follows that the actually existing market potential cannot be fully tapped by any means.

### SUMMARY OF THE INVENTION

The invention provides a remote control unit for wireless control of an electrical microdevice. A band is adapted for being attached to an object worn or carried by a person. Electronic circuitry of the remote control attachable to the band. A housing separate from the object has the electronic circuitry contained therein and provides the attachability to the band The housing is provided with user operable operation elements. At least one operation element of the electronic circuitry is provided in form of a touchpad. The housing is provided with spring clips or clamp-like sections for detachable mounting on said band. The housing is provided with means for detachably mounting on the band. The electronic circuitry is arranged within the band. User operable operation elements of the electronic circuitry are arranged within the band. At least one operation element of the electronic circuitry is provided in form of a touchpad. The object is provided with a holder band that can be mounted in detachable fashion. The remote control unit is designed to be mounted on bands of different sizes and wherein the electronic circuitry is housed in a centrally located enclosure having several resilient legs comprising at least one of an elastomeric polymer, a rubber-like material, and a metallic material coated with a rubber-like material. The microdevice is one of a hearing aid and an implanted medical device.

The band is designed to be attachable to an object of daily use and typically worn or carried on a regular basis by a person utilizing a communication transceiver or a hearing aid. That object may be a wristwatch, a pocket watch, a bracelet, a jewelry item, a piece of clothing, a belt, etc.

It is possible, for example, to provide the housing or enclosure with spring clips or clamping sections allowing it to be attached, preferably in detachable fashion. It is equally possible to attach the housing or enclosure by means of a velcro strip, an adhesive, suction cups or the like.

The power supply for the remote control is preferably in the form of a battery and in particular a flat cell, or of a rechargeable storage battery, for instance a flexible polymer storage cell.

The housing, belt or watchstrap may also be equipped with control elements such as push buttons in the form of conductive polymers, keys located next to the spring clips or clamping sections, etc. The design of the remote control proper need not be discussed in detail at this point since it is not the primary object of this invention. In this context, reference is instead made to EP 1 247 423 and/or other publications on the subject, such as U.S. Pat. No. 4,063,410, DE 36 42 828 or EP 0 298 323, which contain adequate descriptions of the integration of remote controls for instance in wristwatches.

The preferred implementation of a remote control proposed per this invention for the wireless operation of a hearing aid or communication device is designed as an attachment to a watchband. This remote control that is nearly invisible, permits clip-on attachment to almost any watch design and is easy to operate, lends itself to the attainment of optimal utility and user coverage. The clip-on part is preferably designed to fit the most popular watchbands or watch cases, meaning that it must be either fully adaptable or that it needs to be produced in very few design variations only. The switching functions are implemented for instance by means of switches integrated in the clips or resilient clamps. The entire electronic circuitry is housed in a completely sealed enclosure. A substantial advantage is offered by the fact that the very slim, flat enclosure can be attached to the back of a watchband or wristwatch, making the remote control virtually invisible.

According to a further preferred embodiment it is proposed to arrange the remote control within a band, ribbon or a belt such as in particular a watchstrap. As described above it is also possible within the preferred embodiment to use a watchstrap according to the present invention independently of the type or design of the respective watch, in which the remote control can be arranged for the wireless operation of a hearing aid device, a communication transceiver or a medical device such as an implant. Usually the width of a watchstrap is standardized so that a watchstrap according to the invention can be attached at more or less each watch or at least at the usually used type of watches. But it is also possible to shape the assembling area of the watchstrap in such a way, that the installation of a watchstrap to non-standardized watches is possible. The remote control operation elements can be designed, for example, in form of pushbuttons arranged within the watchstrap, length shaped flexible touch pads, etc. These operation elements can project through the band or be contained within the band and operable, for example, by pressing on the band. The power supply for the remote control can be in form of flexible batteries integrated within the watchstrap such as e.g. lithium-polymer batteries. Of course the present invention is not limited to remote control or wireless operation of a hearing aid device or a communication transceiver, but it is also possible to guide or operate wireless medical implants or to influence their functionality.

### BRIEF DESCRIPTION FO THE DRAWING FIGURES

The following describes this invention by way of examples and with reference to the attached drawings in which—

FIG. 1 is a perspective top view of a conventional wristwatch;

FIG. 2 is a bottom view of the same wristwatch;

FIG. 3 is a bottom view schematically depicting another configuration of the attachment of a remote control to a wristwatch;

FIG. 4 again a conventional wristwatch in perspective view with a remote control arranged within a watchstrap;

FIG. 5 again a conventional wristwatch in top view with a further embodiment of a remote control within a watchstrap;

FIG. 6 a wristwatch with endless watchstrap in side view including a further switching possibility within the watchstrap, and

FIG. 7 a watch casing in top view onto the dial face including a further display to indicate various functions.

### DESCRIPTION OF THE INVENTION

A wristwatch 1 with a watch band 3 and a control element 5 is equipped with a hearing-aid remote control according to this invention, identifiable in FIG. 1 only by two spring clips 7.

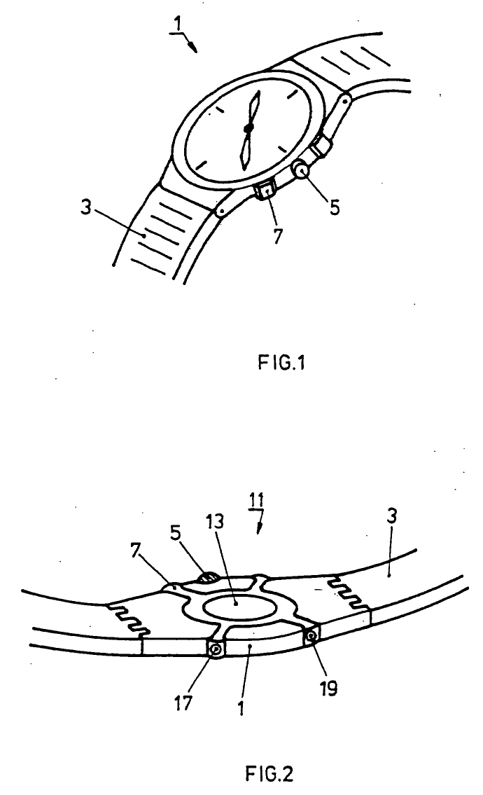

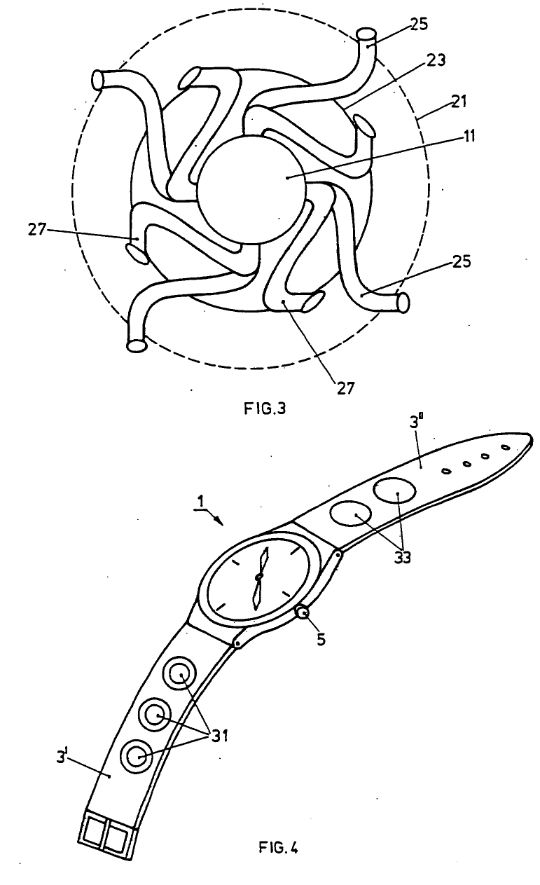

FIG. 2 is a perspective bottom view of the wristwatch 1, clearly showing the remote control. The electronic circuitry, i.e. the remote control unit 11, is accommodated in an enclosure 13 on the back of the watch case 1. The retaining feature holding the enclosure 13 in place is a clip-on element with the spring clips 7 that were visible in FIG. 1. The clamping function is obtained by snapping the clamping sections i.e. spring clips 7 over the rim of the wristwatch. These clamping sections may consist of two or more such spring clips or even a full annular clamp. As a possible variation, per the example described below in reference to FIG. 3, the legs of the clips may be spring-loaded in a way as to allow for an adaptation to different watch sizes. Equally possible are design variations with a fixed counterpart on the back of the device or wristwatch to which the remote-control clip can be attached. The fixed counterparts can be mounted on any objects such as bracelets, belts etc. or on the wristwatch illustrated in FIGS. 1 and 2, while the remote-control clip can then be relocated at will and as necessary.

FIG. 3 schematically illustrates in a perpendicular bottom view another mode of attaching a remote control 11 to the back of a wristwatch. In this case it is spring-loaded or resilient legs 25 and, respectively, 27 that fasten the remote control 11 on the perimeter of a wristwatch of which two different sizes are schematically indicated in FIG. 3. One would be a larger wristwatch (dashed outline) such as a men's watch 21 while the other watch with a smaller diameter 23 (solid circular line) may be a ladies' watch. Depending on the size of the watch the legs 25 and 27 are deflected more strongly or, given their resilient restoring force, retracted more tightly, permitting the remote control to be firmly held in place on the bottom side of the wristwatch. The legs 25 and 27 may consist for instance of an elastomeric polymer, or of a rubber-like material such as hydrophilic rubber, one example being unobtaniuim. It is equally possible to employ resilient metal legs coated for instance with a hydrophilic rubber.

As an alternative to the fastening provisions per FIGS. 1, and 3 other forms of attachment may be used, for instance velcro fasteners, adhesives, suction cups or the like. These other fastening variations make it possible to mount the remote control module almost anywhere i.e. on nearly any object, attaching and removing it at any time with a high degree of flexibility. This flexibility and detachability allows for the use of the remote control module independent of any wristwatch.

As alternative to the use of a casing or an envelope as described with reference to FIGS. 1 to 3 it is also possible to arrange a remote control within a band, ribbon or belt, as in particular and preferably within a watchstrap. Correspondingly in FIG. 4 there is shown again in perspective view a conventional wristwatch 1, comprising two separable watchstrap parts 3′ and 3″. In the one watchstrap part 3′ there are arranged e.g. on pressure operable parts 31, provided for the operation e.g. of a hearing aid device or a communication transceiver. These areas, operable on pressure or pushbutton-like elements, can be integrated e.g. within a leather band. If the watchstrap is made out of a polymer material such like a conventional plastic it is also possible to integrate these parts or areas for operations or pushbutton-like elements directly into the watchstrap at the production by extrusion. For the power supply e.g. flexible polymer storage cells are arranged within the other watchstrap part 3″, as e.g. lithium-polymer storage cells. Of course it is also possible to arrange exchangeable knob-like batteries within a watchstrap, as today such small knob-like batteries are offered on the market, which can be incorporated in a respective receiving casing within a watchstrap without problems.

FIG. 5 shows again a conventional wristwatch 1 in top view with its watchstrap parts 3′ and 3″ arranged in opened position.

In the design according to FIG. 5 within one of the watchstrap parts 3′ a touchpad 35, extended in length direction, is arranged, while in the other watchstrap 3″ e.g. a menu switch is arranged within a part or area 37, operable with pressure. Again two flat, preferably flexible polymer batteries 3′″ are shown suggestively. Within the design according to FIG. 5 it is possible to switch between different menus by using the operation element 37, such as e.g. the sound volume. With the touchpad 35 along the length extended pad the sound volume can be adjusted dependent on the area of touch operation.

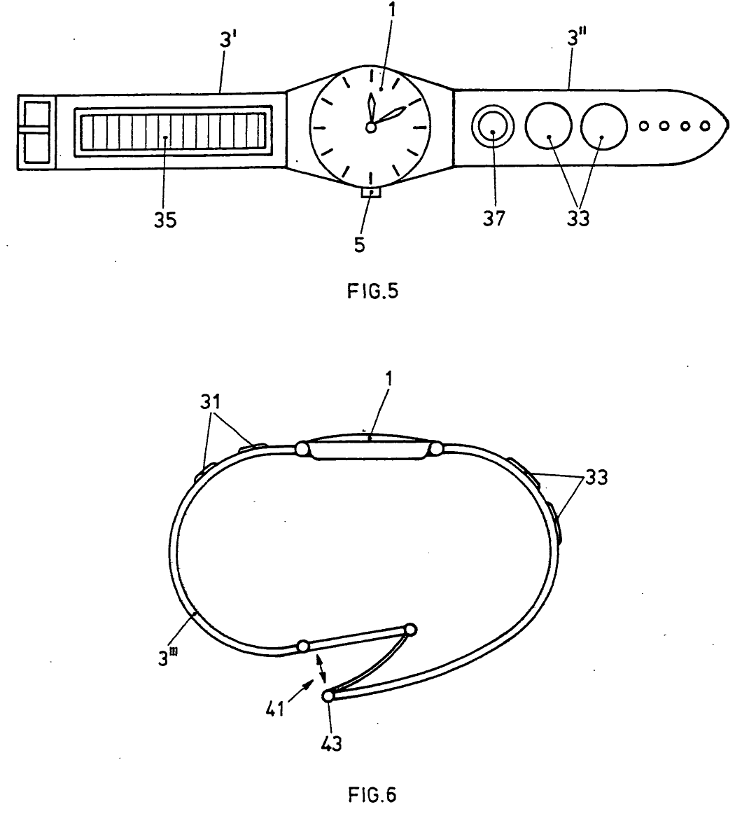

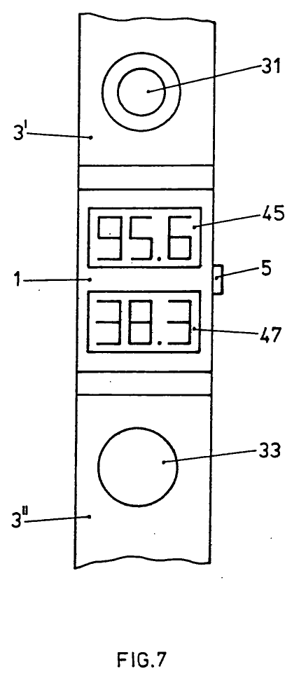

Within the design according to FIG. 6, at which a so-called endless watchstrap 33 is used, it is possible to include further operation possibilities within the closure or fastener 41. It is e.g. possible to activate or deactivate the remote control by opening or closing the closure or fastener 41 or 43 respectively. Or by opening of the closure or fastener 41 or 43 respectively the remote control can be switched into a reduced or lowered operation mode, so that the energy consumption of the remote control can be reduced substantially.

In FIG. 7 it is shown that within a clock face 1 of a watch besides the indication of time further displays can be arranged, as schematically designated in FIG. 7 with the referential number 47. This additional display can be arranged integral within the clock face 1, which in fact is in contradiction to the basic idea of the present invention. According to the invention and as described with reference to FIGS. 1 to 3 it is also possible to clip a display tape onto the clock face or this additional display can also be attached or clipped on the watchstrap at any place. Again it is possible to attach this additional display at any other object, as e.g. a bracelet, at a pluggable clip, which can be plugged at a shirt pocket, etc. With reference to FIG. 7 solely the basic idea should be shown, that in addition to the remote control, arranged e.g. within a watchstrap, a display can be arranged to show the settings of the remote control. Whether this display is arranged integral within a watchstrap or another object or additionally in an attachable, pluggable or clippable removable casing or element is not relevant.

As has already been mentioned further above, the power supply may be provided by a battery, preferably a flat cell, or by a rechargeable storage battery in the form of a flexible polymeric storage cell. Suitable power sources could also include active elements such as a thermoelectric converter, a piezoelectric converter, solar cells and the like. These electric power sources may also be used in combination with a storage battery, thus considerably extending the effective charge of the latter.

The remote control can be operated by means of keys or buttons incorporated for instance in the clips 7 clamped around the rim of the wristwatch or within a watchstrap in the form of push-buttons. Operating controls of that type are symbolized in FIGS. 2 and 4-6 by reference numbers 17, 19, 31 and 37.

It is also possible, however, to perform the switching functions using conductive polymers provided on the remote-control mount, on the enclosure or on the clamping sections of the housing or on or within the watchstrap.

Finally, as an alternative, the clip, housing or enclosure with the remote control module can be produced by a stereolithographic or a so-called additive process. This allows for the customization of a ‘tailor-made’ remote-control attachment, and thus a personalized clip-on solution, mountable on a watch, a cell phone, a ring, a clothing item etc., for each individual customer.

What is claimed is:

1. A remote control unit for wireless control of an electrical microdevice comprising:
a band adapted for being attached to an object worn or carried by a person; and
electronic circuitry of the remote control arranged within the band.

2. The remote control according to claim 1, characterized in that user operable operation elements of the electronic circuitry are arranged within the band.

3. The remote control according to claim 2, characterized in that at least one operation element of the electronic circuitry is provided in form of a touchpad.

4. The remote control according to claim 2, characterized in that at least one operation element of the electronic circuitry is provided in the form of pressure-operated push buttons.

5. The remote control according to claim 1, further comprising a power supply operatively connected to the electronic circuitry and arranged within the band.

6. The remote control according to claim 1, characterized in that the band includes a closure and in that the electronic circuitry is configured to alter operation of the remote control based upon whether the closure is in an open state or a closed state.

7. The remote control according to claim 1, further comprising a display integrated with the band.

8. The remote control unit as in claim 1 characterized in that the object is provided with a holder band that can be mounted in detachable fashion.

9. The remote control unit as in claim 1 wherein the microdevice is one of a hearing aid and an implanted medical device.

10. A hearing aid with a wireless remote control unit per claim 9 serving for the control of said hearing aid.

11. A medical device with a wireless remote control unit per claim 9 serving for the control of said medical device.

12. A remote control unit for wireless control of an electrical microdevice comprising:
an object worn or carried by a person;
a band attached to the object; and
a housing containing electronic circuitry of the remote control and arranged within the band.

13. The remote control according to claim 12, characterized in that user operable operation elements of the electronic circuitry are arranged within the band.

14. The remote control according to claim 13, characterized in that at least one operation element of the electronic circuitry is provided in form of a touchpad.

15. The remote control according to claim 12, further comprising a power supply operatively connected to the electronic circuitry and arranged within the band.

16. The remote control according to claim 12, characterized in that the band includes a closure and in that the electronic circuitry is configured to alter operation of the remote control based upon whether the closure is in an open state or a closed state.

17. The remote control according to claim 12, further comprising a display integrated with the band.

18. The remote control unit as in claim 12 wherein the microdevice is one of a hearing aid and an implanted medical device.

19. A hearing aid with a wireless remote control unit per claim 18 serving for the control of said hearing aid.

20. A medical device with a wireless remote control unit per claim 18 serving for the control of said medical device.
